(19) United States
(12) Patent Application Publication
(10) Pub. No.: US 2010/0240310 A1
(43) Pub. Date: Sep. 23, 2010

(54) EARPIECE

(76) Inventor: Hung-Yi HUANG, Taoyuan County (TW)

Correspondence Address: BIRCH STEWART KOLASCH & BIRCH, PO BOX 747, FALLS CHURCH, VA, 22040-0747, US

(21) Appl. No.: 12/624,306

(22) Filed: Nov. 23, 2009

(30) Foreign Application Priority Data
Mar. 18, 2009 (TW) 098108718

(51) Int. Cl. H04B 7/00; H04R 1/10

(52) U.S. Cl. 455/41.3; 381/379

(57) ABSTRACT

The invention provides an earpiece. The earpiece includes a main body and a speaker disposed in the main body. The main body includes a sound output member and a bending member connected to the sound output member, wherein the sound output member and the bending member are integrally formed as a single piece.

This Application claims priorities of Taiwan Patent Application No. 98108718, filed on Mar. 18, 2009, the entirety of which is incorporated by reference herein.

### BACKGROUND OF THE INVENTION

1. Field of the Invention

The invention relates to an earpiece, and in particular, to an earpiece which is convenient to be worn on a left or right ear.

2. Description of the Related Art

The conventional single earpiece with earloop is usually worn on a specific ear of the user. Although there are earpieces designed to be worn on a left or right ear of the user, manual disassembly of the earloop is required for adjustment. Specifically, the earloop is separated from the main body of the earpiece and then is reassembled to the main body in a different direction. Thus, the complicated assembly and the protruded earloop of the earpiece cause inconvenience to users.

### BRIEF SUMMARY OF THE INVENTION

Accordingly, the invention provides an earpiece. The earpiece includes a main body and a speaker disposed in the main body. The main body includes a sound output member and a bending member connected to the sound output member, wherein the sound output member and the bending member are integrally formed as a single piece.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B are schematic views of an earpiece of the invention from different perspectives;

FIGS. 2A and 2B are schematic views of the earpiece of the invention showing a bending member bent toward different directions corresponding to a sound output member;

FIG. 3 is a schematic view of an variant embodiment of the earpiece of the invention; and

FIG. 4 is a schematic view of another variant embodiment of the invention.

### DETAILED DESCRIPTION OF THE INVENTION

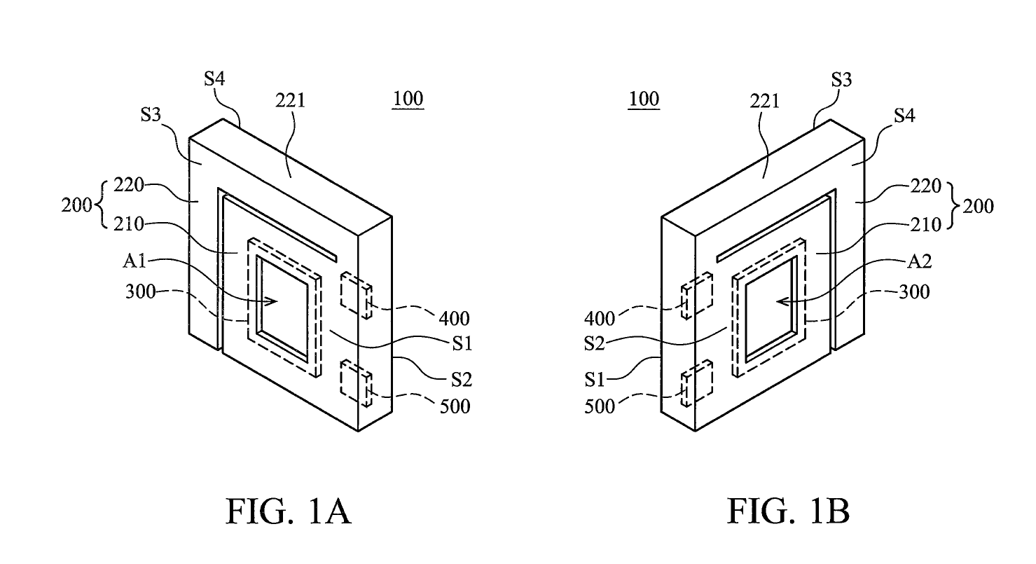

Referring to FIG. 1A and FIG. 1B, an earpiece 100 of the invention comprises a main body 200, a speaker 300, a Bluetooth module 400 and a receiver 500, wherein the electronic components, such as the speaker 300, the Bluetooth module 400 and the receiver 500, are all disposed in the main body 200.

The main body 200 comprises a sound output member 210 and a bending member 220, wherein the sound output member 210 and the bending member 220 are formed integrally as a single piece. Additionally, the earpiece is made of rubber or silica gel via an injection molding process, but it is not limited thereto. The main body 200 can also be made of other materials which are elastic or flexible.

The sound output member 210 has a first surface S1 (as shown in FIG. 1A) and a second surface S2 (as shown in FIG. 1B) opposite to the first surface S1, and the first surface S1 and the second surface S2 respectively have a first opening A1 (as shown in FIG. 1A) and a second opening A2 (as shown in FIG. 1B).

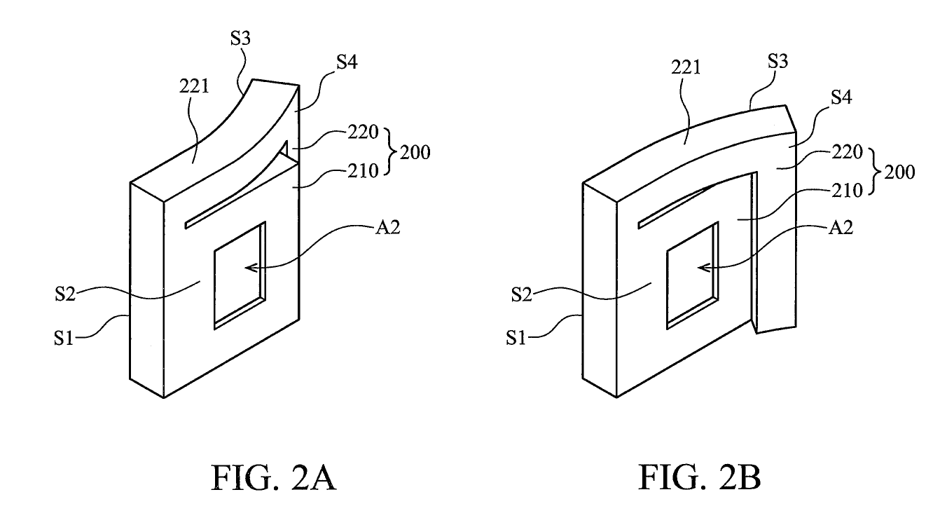

Referring to FIG. 2A and FIG. 2B simultaneously, the bending member 220 is L-shaped, comprising an end portion 221, a third surface S3 and a fourth surface S4. The bending member 220 connects with the sound output member 210 in a bendable manner through the end portion 221(as shown in FIGS. 2A and 2B). The third surface S3 connects with the first surface S1 and flushes with the first surface S1, while the fourth surface S4 connects with the second surface S2 and flushes with the second surface S2.

It should be noted that in the embodiment the third surface S3 flushes with the first surface S1, and the fourth surface S4 flushes with the second surface S2, but it is not limited thereto. The above described surfaces can also comprise curved shapes according to the shape of the ear in order to be more ergonomic.

Referring to FIG. 1A and FIG. 1B again, the speaker 300 is an electroacoustic transducer disposed in the sound output member 210. When the speaker 300 generates sound, the sound is transmitted to the exterior via the first opening A1 and the second opening A2 of the sound output member 210. To wear the earpiece, the user may bend the bending portion 220 with respect to the sound output member 210. Afterwards, the sound output member 210 is plugged into the opening of the external auditory meatus and the bending member 220 is hooked on the auricle. Therefore, the user can receive sound by the sound output member 210.

It should be noted that in the embodiment the speaker 300 is an electroacoustic transducer, but it is not limited thereto. The speaker 300 may also be a coil speaker, a piezoelectric speaker or other type of speaker.

Referring to FIGS. 2A and 2B, when the bending member 220 is bent left with respect to the sound output member 210 (as shown in FIG. 2A), the user can wear the earpiece 100 on his left ear and receive sound through the first opening A1 on the first surface S1. When the bending member 220 is bent right with respect to the sound output member 210 (as shown in FIG. 2B), the user can wear the earpiece 100 on his right ear and receive sound through the second opening A2 on the second surface S2.

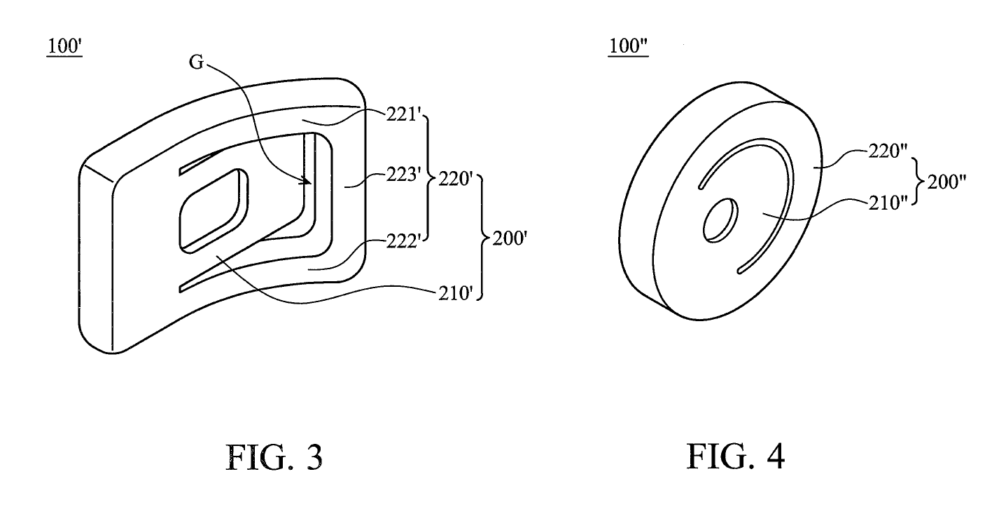

Referring to FIG. 3, in a variant embodiment, the bending member 220′ of the main body 200′ is U-shaped, comprising a first end portion 221′, a second end portion 222′ and a middle portion 223′. The first end portion 221′ and the second end portion 222′ respectively connect to the sound output member 210′, and the middle portion 223′ connects with the first end portion 221′ and the second end portion 222′. A gap G is formed between the middle portion 223′ and the sound output member 210′. By bending the first end portion 221′ and the second end portion 222′, the bending member 220′ is bent toward the left direction or the right direction relative to the sound output member 210′, allowing widening of the gap G. Therefore, the user can place the auricle into the gap G, and fasten the earpiece 100 on the ear.

It should be noted that in the above embodiments the bending members 220, 220′ are L-shaped and U-shaped, but it is not limited thereto. The bending member can be in other shapes. Referring to FIG. 4, in another variant embodiment, the bending member 220″ together with the sound output member 210″ of the earpiece 100″ form a circular main body 200″, of which a curved bending member 220″ is presented.

The earpiece of the invention comprising a bending member randomly bent toward the left direction or the right direction, allows the user to wear the earpiece on the left ear or the right ear. Furthermore, the main body of the earpiece is elastic, which does not cause an uncomfortable feeling to the user. When the bending member is bent to its original position, the third surface S3 flushes with the first surface S1, and the fourth surface S4 flushes with the second surface S2. Thus, the earpiece is convenient to carry. In addition, because the earpiece is made of elastic material via injection molding, the earpiece of the invention may cost less than the conventional earpiece assembled by multiple parts.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An earpiece, comprising:
a main body, comprising:
a sound output member; and
a bending member connected to the sound output member, wherein the sound output member and the bending member are integrally formed as a single piece; and
a speaker, disposed in the main body.

2. The earpiece as claimed in claim 1, wherein the speaker is disposed within the sound output member.

3. The earpiece as claimed in claim 2, wherein the sound output member has a first surface, the first surface has a first opening, and sound generated by the speaker is transmitted to the exterior through the first opening.

4. The earpiece as claimed in claim 3, wherein the sound output member has a second surface opposite to the first surface, the second surface has a second opening, and sound generated by the speaker is transmitted to the exterior through the first opening and the second opening.

5. The earpiece as claimed in claim 4, wherein the bending member has a third surface, and the third surface connects with the first surface.

6. The earpiece as claimed in claim 5, wherein the bending member has a fourth surface, and the fourth surface connects with the second surface.

7. The earpiece as claimed in claim 1, wherein the speaker is a coil speaker, a piezoelectric speaker or an electroacoustic transducer.

8. The earpiece as claimed in claim 1, wherein the main body is made of elastic material or flexible material.

9. The earpiece as claimed in claim 1, wherein the main body is made of rubber or silica gel.

10. The earpiece as claimed in claim 1, wherein the bending member has a first end portion connecting to the sound output member, and the bending portion connects with the sound output member in a bendable manner via the first end portion.

11. The earpiece as claimed in claim 10, wherein the bending member has a second end portion connecting to the sound output member, and the bending portion connects with the sound output member in a bendable manner via the second end portion.

12. The earpiece as claimed in claim 11, wherein the bending portion has a middle portion between and connecting the first end portion and the second end portion, and a gap is formed between the middle portion and the sound output member.

13. The earpiece as claimed in claim 1, further comprising a Bluetooth module disposed in the main body.

14. The earpiece as claimed in claim 1, further comprising a receiver disposed in the main body.

15. The earpiece as claimed in claim 1, wherein the bending portion is L-shaped, U-shaped or curved shape.
